(19) United States
(12) Patent Application Publication
(10) Pub. No.: US 2022/0164084 A1
(43) Pub. Date: May 26, 2022

(54) TOUCH-PANEL-EQUIPPED DISPLAY DEVICE

(71) Applicant: SHARP KABUSHIKI KAISHA, Sakai City (JP)

(72) Inventor: TAHEI NAKAUE, Sakai City (JP)

(21) Appl. No.: 17/498,711

(22) Filed: Oct. 11, 2021

Related U.S. Application Data
(60) Provisional application No. 63/117,165, filed on Nov. 23, 2020.

(51) Int. Cl. G06F 3/041; G06F 3/044

(52) U.S. Cl. CPC G06F 3/04164; G06F 3/0446; G06F 3/0445

(57) ABSTRACT

A touch-panel-equipped display device includes a touch panel configured to display an image thereon and detect a touch and a control unit configured to control the display of the image and the detection of the touch on the touch panel. The touch panel includes: a plurality of first touch detection electrodes arranged so as to overlap a display area in a plan view; and a plurality of second touch detection electrodes arranged so as to overlap the display area in a plan view, the plurality of second touch detection electrodes being less numerous than the plurality of first touch detection electrodes. The control unit performs the detection of the touch using the plurality of first touch detection electrodes when an image is being displayed on the touch panel and using the plurality of second touch detection electrodes when no image is being displayed on the touch panel.

### CROSS-REFERENCE TO RELATED APPLICATION

The present application claims priority from Provisional Application No. 63/117,165, the content to which is hereby incorporated by reference into this application.

### BACKGROUND OF THE INVENTION

### 1. Field of the Invention

The disclosure relates to touch-panel-equipped display devices.

### 2. Description of the Related Art

Touch-panel-equipped display devices are known that include an in-cell touch panel including a plurality of touch sensor electrodes on a substrate. Japanese Unexamined Patent Application Publication, Tokukai, No. 2017-27224 discloses such a touch-panel-equipped display device. The touch-panel-equipped display device described in this Japanese Unexamined Patent Application Publication, Tokukai, No. 2017-27224 is structured such that its image display area and touch electrode area overlap in a plan view.

### SUMMARY OF THE INVENTION

The touch-panel-equipped display device described in Japanese Unexamined Patent Application Publication, Tokukai, No. 2017-27224 can be so arranged as to detect, for example, a finger touch on the touch panel in a period when no image is being displayed on the touch panel (during standby) as well as in a period when an image is being displayed on the touch panel. To achieve this, voltage needs to be continuously applied to the plurality of touch sensor electrodes even when no image is being displayed on the touch panel, which undesirably adds to the power consumption of the touch-panel-equipped display device. The term, “standby,” in this context refers to the condition where the control circuit of the display device is supplied with electric power, but no image is being displayed on the touch panel.

This disclosure has been made to address these issues and has an object to provide a touch-panel-equipped display device capable of suppressing increases in power consumption in a touch detection performed when no image is being displayed on the touch panel.

To address the issues, the present disclosure, in an aspect thereof, is directed to a touch-panel-equipped display device including: a touch panel configured to display an image thereon and detect a touch made by a user thereon; and a control unit configured to control the display of the image and the detection of the touch on the touch panel, the touch panel including: a plurality of first touch detection electrodes arranged so as to overlap a display area where the image is displayed in a plan view; and a plurality of second touch detection electrodes arranged so as to overlap the display area in a plan view, the plurality of second touch detection electrodes being less numerous than the plurality of first touch detection electrodes, wherein the control unit performs the detection of the touch using the plurality of first touch detection electrodes when the image is being displayed on the touch panel and using the plurality of second touch detection electrodes when no image is being displayed on the touch panel.

The touch-panel-equipped display device structured as above is capable of suppressing increases in power consumption in a touch detection performed when no image is being displayed on the touch panel.

### BRIEF DESCRIPTION OF DRAWINGS

FIG. 1 is a schematic cross-sectional view of a display device (touch-panel-equipped display device) in accordance with an embodiment.

FIG. 2 is a schematic circuit diagram of a structure of pixels.

FIG. 3 is a schematic plan view of an exemplary arrangement of first touch detection electrodes and second touch detection electrodes in accordance with an embodiment.

FIG. 4 is a diagram illustrating a touch detection area of a first touch detection electrode and a touch detection area of a second touch detection electrode in accordance with an embodiment.

FIG. 5 is a cross-sectional view taken along line 1000-1000 shown in FIG. 3.

FIG. 6 is a diagram illustrating the cycle of touch detection performed using the first touch detection electrodes in accordance with an embodiment.

FIG. 7 is a diagram illustrating the cycle of touch detection performed using the second touch detection electrodes in accordance with an embodiment.

FIG. 8 is a diagram illustrating a structure of a touch panel in accordance with a comparative example for an embodiment.

### DETAILED DESCRIPTION OF THE INVENTION

The following will describe an embodiment of the present disclosure with reference to drawings. Identical and equivalent members will be denoted by the same reference signs throughout the drawings, and description thereof is not repeated.

### Structure of Display Device

FIG. 1 is a schematic cross-sectional view of a display device 100 (touch-panel-equipped display device) in accordance with the present embodiment. Referring to FIG. 1, the display device 100 includes a touch panel 1. The touch panel 1 is structured so as to serve also as a display panel for displaying a video or an image. The touch panel 1 includes an active matrix substrate 10, an opposite substrate 20, and a liquid crystal layer 30 interposed between the active matrix substrate 10 and the opposite substrate 20. The touch panel 1 further includes a pair of polarizers 40a and 40b sandwiching the active matrix substrate 10 and the opposite substrate 20. There is provided a cover glass 50 on the front of the polarizer 40b via an adhesive layer (not shown). There is also provided a backlight 60 facing the polarizer 40a.

The touch panel 1 produces an image display on the front side (hereinafter, touch surface) of the cover glass 50 so that the user can visually recognize the image. The touch panel 1 further receives a touch operation made by the user with, for example, his/her finger (indicator) on the touch surface of the cover glass 50. The liquid crystal molecules in the liquid crystal layer 30 are driven in in-plane switching mode in the touch panel 1. To enable in-plane switching, there are provided pixel electrodes and an opposite electrode (common electrode provided common to the pixel electrodes) on the active matrix substrate 10 to produce an electric field. The active matrix substrate 10 includes formed thereon electronic elements that are needed to detect a touch position. In other words, the display device 100 is a display device that includes a so-called in-cell touch panel.

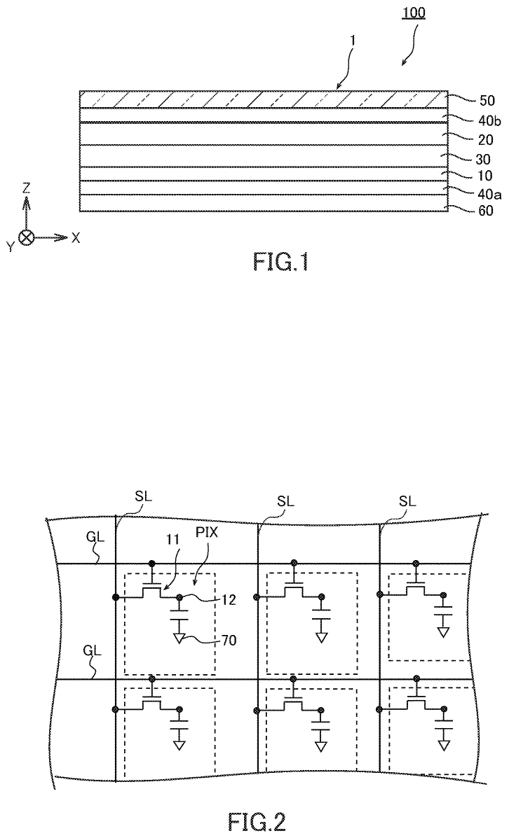

FIG. 2 is an equivalent circuit diagram of pixels in the active matrix substrate 10. The active matrix substrate 10 includes a plurality of gate lines GL and a plurality of data lines SL intersecting with the plurality of gate lines GL. On the active matrix substrate 10 is there provided a plurality of pixels PIX delineated by the data lines SL and the gate lines GL. Each pixel PIX includes a thin film transistor (TFT) 11 and a pixel electrode 12. The pixel electrode 12 provides a capacitance C between the pixel electrode 12 and a first touch detection electrode 70 that functions as an opposite electrode (common electrode). Each first touch detection electrode 70 is provided common to some of the pixel electrodes 12 (detailed later). The TFT 11 has a gate thereof connected to the gate line GL, a source thereof connected to the data line SL, and a drain thereof connected to the pixel electrode 12. The pixel electrode 12 is, for example, made from a transparent conductive film of, for example, ITO.

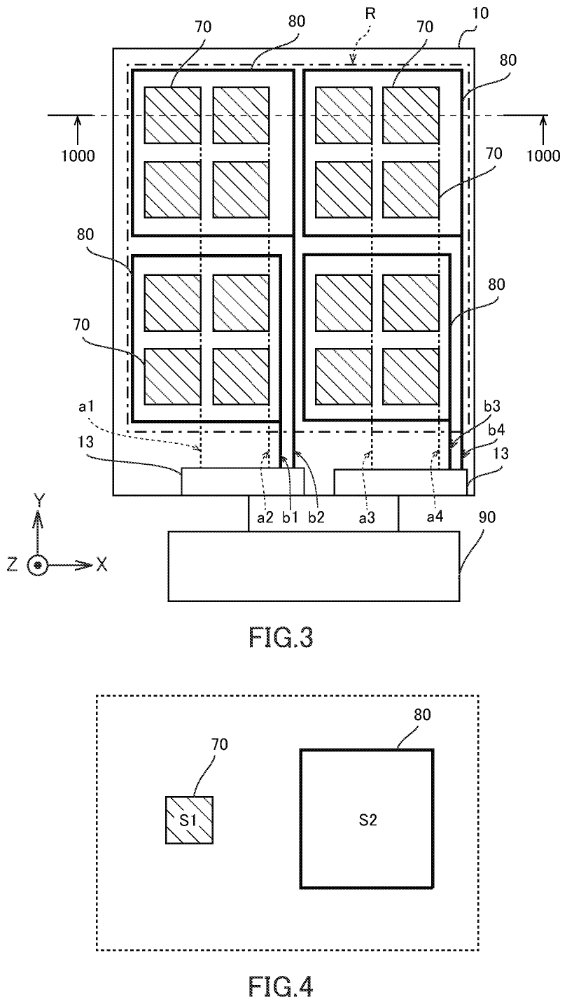

FIG. 3 is a schematic plan view of an exemplary arrangement of the first touch detection electrodes 70 and second touch detection electrodes 80 on the active matrix substrate 10. The active matrix substrate 10 includes the first touch detection electrodes 70 and the second touch detection electrodes 80. The first touch detection electrodes 70 and the second touch detection electrodes 80 are connected to respective driver circuits 13. The driver circuits 13 are arranged so as to apply a voltage to the first touch detection electrodes 70 and the second touch detection electrodes 80 on the basis of instructions from a host controller 90 that is configured to serve as a control unit for the display device 100.

In the present embodiment, the second touch detection electrodes 80 are less numerous than the first touch detection electrodes 70. For instance, the second touch detection electrodes 80 are outnumbered by the first touch detection electrodes 70 by at least four to one.

As shown in FIG. 3, in a plan view, the first touch detection electrodes 70 are arranged in a matrix in locations where the first touch detection electrodes 70 overlap an image display area R of the touch panel 1. The first touch detection electrodes 70 are rectangular in a plan view. The first touch detection electrodes 70 may be, for example, transparent ITO electrodes or meshed metal electrodes.

Furthermore, as shown in FIG. 3, in a plan view, the second touch detection electrodes 80 are arranged in a matrix in locations where the second touch detection electrodes 80 overlap the display area R. The second touch detection electrodes 80 may be, for example, transparent ITO electrodes or meshed metal electrodes. The second touch detection electrodes 80 are shaped like rings surrounding the first touch detection electrodes 70 in a plan view. This particular structure can reduce the capacitance of each second touch detection electrode 80 over the structure where the second touch detection electrodes are shaped like flat plates. That can in turn reduce the drive current in a touch detection performed using the second touch detection electrodes 80 and also reduce capacitive coupling between the second touch detection electrodes 80 and the first touch detection electrodes 70. The reduced drive current enables further decreases in the power consumption of the display device 100. The reduced capacitive coupling enables preventing negative effects of changes in the capacitance produced between the second touch detection electrodes 80 and, for example, a finger in a touch detection performed using the first touch detection electrodes 70 and preventing negative effects of changes in the capacitance produced between the first touch detection electrodes 70 and, for example, a finger in a touch detection performed using the second touch detection electrodes 80.

FIG. 3 shows an example in which each ring-shaped second touch detection electrode 80 surrounds four first touch detection electrodes 70. Alternatively, the ring-shaped second touch detection electrode 80 may surround less than four or more than four first touch detection electrodes 70. In addition, FIG. 3 shows the first touch detection electrodes 70 and the second touch detection electrodes 80 being each rectangular. Alternatively, the first touch detection electrodes 70 and the second touch detection electrodes 80 may, for example, be each rhombic, polygonal (non-rectangular), or circular.

FIG. 4 is a diagram illustrating a touch detection area of the first touch detection electrode 70 and a touch detection area of the second touch detection electrode 80. In a plan view, each first touch detection electrode 70 has a touch detection area equal to S1, and each second touch detection electrode 80 has a touch detection area equal to S2 that is larger than S1. The “touch detection area” in this context refers to the area of the region in which a finger, as an example, can be detected using either the first touch detection electrode 70 or the second touch detection electrode 80. For instance, S1 is equal to the area of the first touch detection electrode 70 when the first touch detection electrode 70 is viewed in a plan view. S2 is equal to the sum of the area of the region in which the second touch detection electrode 80 is formed and the area of the region surrounded by the second touch detection electrode 80, both in a plan view. For instance, area S2 is at least 4 times greater than area S1. In this particular structure, the precision (resolution) of touch detection is higher when the first touch detection electrodes 70 are used than when the second touch detection electrodes 80 are used. Additionally, since the second touch detection electrode 80 provides a larger touch area than does the first touch detection electrode 70, the second touch detection electrodes 80 may be less numerous than the first touch detection electrodes 70 to cover the entire display area R.

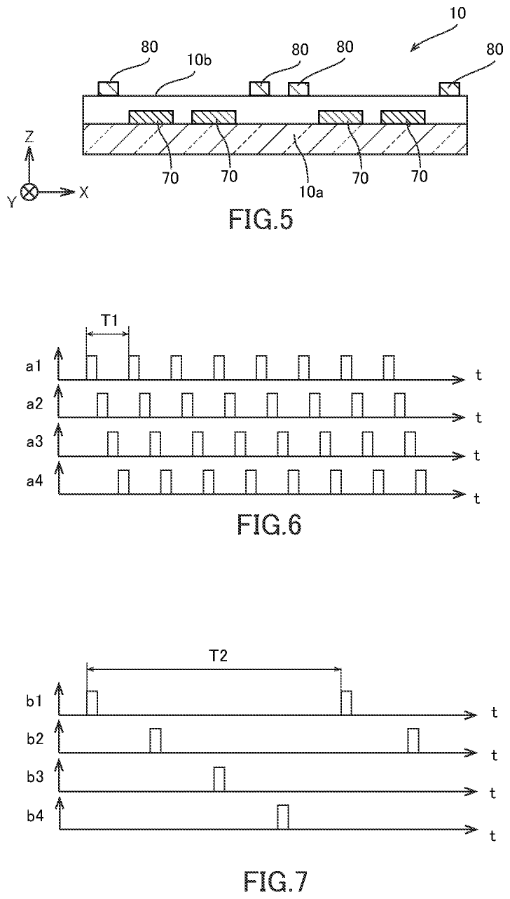

FIG. 5 is a cross-sectional view taken along line 1000-1000 shown in FIG. 3, illustrating a structure of the first touch detection electrodes 70 and the second touch detection electrodes 80 on the active matrix substrate 10. FIG. 5 only shows the structure of the first touch detection electrodes 70 and the second touch detection electrodes 80 for convenience of illustration. The first touch detection electrodes 70 are formed on a glass substrate 10a. An insulation layer 10b is formed so as to cover the first touch detection electrodes 70. The second touch detection electrodes 80 are formed on the insulation layer 10b. In other words, the second touch detection electrodes 80 are formed in a different layer on the active matrix substrate 10 than are the first touch detection electrodes 70. The insulation layer 10b is interposed between the second touch detection electrodes 80 and the first touch detection electrodes 70. In this particular structure, since the first touch detection electrodes 70 are formed in a different layer than are the second touch detection electrodes 80, the first touch detection electrodes 70 and the second touch detection electrodes 80 can be formed without making any contacts therebetween even when at least parts (e.g., wiring portions) of the first touch detection electrodes 70 overlap or intersect with at least parts (e.g., wiring portions) of the second touch detection electrodes 80 in a plan view as shown in FIG. 3.

The part of the first touch detection electrode 70 in which a finger, as an example, can be detected (the rectangular part thereof) does not overlap the part of the second touch detection electrode 80 in which a finger, as an example, can be detected (the ring-shaped part thereof) in a plan view, as shown in FIG. 5. This particular structure can prevent a finger, as an example, from being capacitively coupled to either the first touch detection electrodes 70 or the second touch detection electrodes 80 before a touch detection is performed using the others. This mechanism in turn enables preventing negative effects of capacitive coupling in performing a touch detection using either the first touch detection electrodes 70 or the second touch detection electrodes 80.

FIG. 6 shows an exemplary waveform of a drive signal transmitted to the first touch detection electrodes 70. FIG. 7 shows an exemplary waveform of a drive signal transmitted to the second touch detection electrodes 80. The host controller 90 (see FIG. 3) is a control circuit in the display device 100 and includes a processor for performing controlling processes by executing programs. The host controller 90 controls the display produced on the touch panel 1 and also controls the touch detection performed on the touch panel 1. In the present embodiment, the host controller 90 performs a touch detection using the first touch detection electrodes 70 when an image is being displayed on the touch panel 1 and performs a touch detection using the second touch detection electrodes 80 when no image is being displayed on the touch panel 1. In other words, the host controller 90 performs a touch detection using only the second touch detection electrodes 80 without performing touch detection using the first touch detection electrodes 70 when no image is being displayed on the touch panel 1 (during standby). Meanwhile, the host controller 90 performs a touch detection using only the first touch detection electrodes 70 without performing touch detection using the second touch detection electrodes 80 when an image is being displayed on the touch panel 1. The term, “standby,” refers to the condition where the host controller 90 is supplied with electric power, but no image is being displayed on the touch panel 1.

In this context, “performing touch detection when an image is being displayed on the touch panel 1” refers to, for example, producing an image display and performing touch detection by time division in one frame period. The host controller 90 applies a constant voltage to at least the first touch detection electrodes 70 among all the first touch detection electrodes 70 and the second touch detection electrodes 80 when an image display is produced and applies a drive signal for touch detection to the first touch detection electrodes 70 when a touch detection is performed. “Performing touch detection when no image is being displayed on the touch panel 1” refers to intermittently (or continuously) performing touch detection without producing an image display. For instance, the language, “when no image is being displayed on the touch panel 1,” is inclusive of the condition where the main power supply is turned off (but, the host controller 90 is being supplied with electric power) and the condition where the display device 100 is operating on low electric power (the condition where no electric power is being supplied to, for example, the display control circuit (detailed later) and the condition where the backlight 60 is turned off).

Referring to FIGS. 6 and 7, the host controller 90 transmits an instruction signal to the driver circuits 13, so that the driver circuits 13 can transfer a drive signal to all the first touch detection electrodes 70 and the second touch detection electrodes 80. A “drive signal” is represented by, for example, a voltage with a pulsatile waveform. A touch detection is performed using the first touch detection electrodes 70 and the second touch detection electrodes 80 when a drive signal is transferred (when a voltage is applied by the driver circuits 13). Specifically, the host controller 90, when transferring a drive signal, detects a change in the capacitance of the first touch detection electrodes 70 or the second touch detection electrodes 80 and acquires the change in the capacitance as a touch detection. To describe in more detail, the first touch detection electrodes 70 and the second touch detection electrodes 80 have a parasitic capacitance when the user's finger is not in contact with the touch surface. When the finger comes into contact with the touch surface, the finger creates capacitance between the finger and one of the first touch detection electrodes 70 or the second touch detection electrodes 80 that is close to the contact location, which changes the capacitance of that one of the first touch detection electrodes 70 or the second touch detection electrodes 80. Then, a signal that is in accordance with the capacitance of that one of the first touch detection electrodes 70 or the second touch detection electrodes 80 is outputted to the host controller 90 via the driver circuits 13, so that the host controller 90 can detect the touch with the finger on the touch panel 1.

In the present embodiment, when an image is being displayed on the touch panel 1, the host controller 90 controls the driver circuits 13 to sequentially transfer a drive signal to only the first touch detection electrodes 70. When no image is being displayed on the touch panel 1, the host controller 90 controls the driver circuits 13 to sequentially and intermittently transfer a drive signal to only the second touch detection electrodes 80. When no image is being displayed on the touch panel 1, this particular mechanism enables performing touch detection using the second touch detection electrodes 80, which are less numerous than the first touch detection electrodes 70, thereby reducing power consumption in a touch detection. Hence, the mechanism can suppress increases in power consumption even in a touch detection performed when no image is being displayed on the touch panel 1.

In addition, in the present embodiment, the drive signal transmitted to the second touch detection electrodes 80 has a period T2, and the drive signal transmitted to the first touch detection electrodes 70 has a period T1, T2 being longer than T1. The power consumption of the touch panel 1 increases with an increasing frequency of touch detection. Nevertheless, according to this mechanism, since period T2 is relatively long, the touch panel 1 does not perform a touch detection so frequently when no image is being displayed on the touch panel 1, which can further reduce power consumption.

For instance, the first touch detection electrodes 70 include a plurality of drive signal transfer systems (four systems a1, a2, a3, and a4 in FIG. 6). The driver circuits 13 sequentially transmit a drive signal to the transfer systems. Those of the first touch detection electrodes 70 which belong to the same transfer system are simultaneously fed with a drive signal.

The driver circuits 13 sequentially transmit a drive signal to the second touch detection electrodes 80 (four second touch detection electrodes b1, b2, b3, and b4 in FIG. 7). When one of the second touch detection electrodes 80 is receiving a drive signal, the other second touch detection electrodes 80 do not receive a drive signal.

The active matrix substrate 10 further includes a display control circuit, a gate driver, and a source driver (none of them shown). The display control circuit supplies the gate driver and the source driver with control signals such as a clock signal and synchronization signals representing timings to write an image (a vertical synchronization signal and a horizontal synchronization signal) when an image is being displayed on the touch panel 1. The gate driver sequentially applies a scan voltage to the gate lines GL when an image is being displayed on the touch panel 1. The source driver applies a data voltage representing the gray levels of a display image to the data lines SL on the basis of the control signals when an image is being displayed on the touch panel 1.

### VARIATION EXAMPLES

The disclosure has been described so far by means of an embodiment. The embodiment disclosed above is however for illustrative purposes only and provides no basis for restrictive interpretations of the disclosure. The embodiment may be modified for implementation where appropriate, without departing from the scope of the disclosure. The following will describe variation examples of the embodiment.

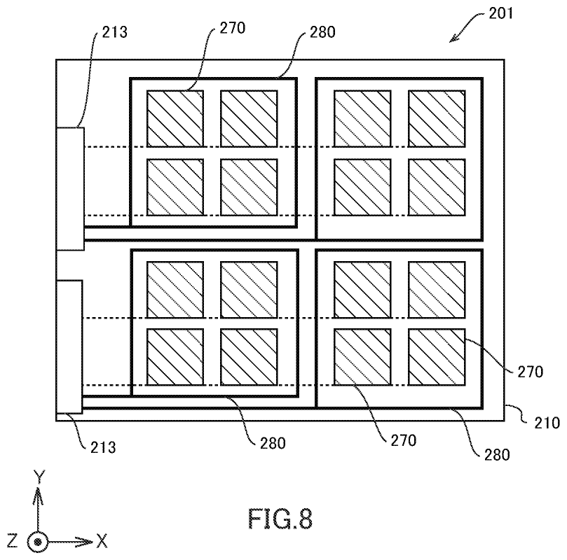

(1) The aforementioned embodiment has given examples where the driver circuits 13 is located in a part of the touch panel 1 toward the negative direction of the Y-axis as shown in FIG. 3. The disclosure is however by no means limited to these examples. Alternatively, a driver circuits 213 may be located on a part of an active matrix substrate 210 toward the negative direction of the X-axis as in a touch panel 201 shown in FIG. 8 in accordance with a variation example. The wiring connecting the driver circuits 213 to first touch detection electrodes 270 and second touch detection electrodes 280 is provided so as to extend in the X-direction.

(2) The aforementioned embodiment has given examples where the touch detection area of each second touch detection electrode 80 (area S2) is larger than the touch detection area of each first touch detection electrode 70 (area S1). The present disclosure is however by no means limited to these examples. Alternatively, for example, the second touch detection electrodes 80 may be separated from each other by such increased intervals that the touch detection area of each second touch detection electrode 80 can be smaller than or equal to the touch detection area of each first touch detection electrode 70.

(3) The aforementioned embodiment has given examples where the second touch detection electrodes 80 are shaped like rings in a plan view. The present disclosure is however by no means limited to these examples. Alternatively, for example, the second touch detection electrodes 80 may be solid in a plan view.

(4) The aforementioned embodiment has given examples where the second touch detection electrodes 80 are provided so as to surround the first touch detection electrodes 70 in a plan view. The present disclosure is however by no means limited to these examples. Alternatively, for example, the second touch detection electrodes 80 may be provided in such locations as to overlap the first touch detection electrodes 70 in a plan view.

(5) The aforementioned embodiment has given examples where the first touch detection electrodes 70 and the second touch detection electrodes 80 are located in different layers. The present disclosure is however by no means limited to these examples. Alternatively, for example, the first touch detection electrodes 70 and the second touch detection electrodes 80 may be located in the same layer so long as the first touch detection electrodes 70 and the second touch detection electrodes 80 are not located in such locations as to overlap each other and do not intersect with each other in a plan view.

(6) The aforementioned embodiment has given examples where the second touch detection electrodes 80 are located in an upper layer of the first touch detection electrodes 70. The present disclosure is however by no means limited to these examples. Alternatively, for example, the second touch detection electrodes 80 may be located in a lower layer of the first touch detection electrodes 70.

(7) The aforementioned embodiment has given examples where a touch detection is performed with period T2 using the second touch detection electrodes 80 and with period T1 using the first touch detection electrodes 70, T2 being longer than T1. The present disclosure is however by no means limited to these examples. Alternatively, for example, a touch detection may be performed with the same period regardless of whether to use the second touch detection electrodes 80 or the first touch detection electrodes 70.

The touch-panel-equipped display device detailed above may be alternatively described as in the following.

A touch-panel-equipped display device in accordance with a first configuration includes: a touch panel configured to display an image thereon and detect a touch made by a user thereon; and a control unit configured to control the display of the image and the detection of the touch on the touch panel, the touch panel including: a plurality of first touch detection electrodes arranged so as to overlap a display area where the image is displayed in a plan view; and a plurality of second touch detection electrodes arranged so as to overlap the display area in a plan view, the plurality of second touch detection electrodes being less numerous than the plurality of first touch detection electrodes, wherein the control unit performs the detection of the touch using the plurality of first touch detection electrodes when the image is being displayed on the touch panel and using the plurality of second touch detection electrodes when no image is being displayed on the touch panel (first configuration).

In the first configuration, the second touch detection electrodes, which are less numerous than the first touch detection electrodes, are used in touch detection when no image is being displayed on the touch panel. The first configuration can therefore reduce power consumption in touch detection over a configuration where the first touch detection electrodes are used in touch detection. The first configuration can hence suppress increases in power consumption even in a touch detection performed when no image is being displayed on the touch panel.

In the first configuration, each of the plurality of second touch detection electrodes may have a larger touch detection area than does each of the plurality of first touch detection electrodes (second configuration).

In the second configuration, even when the second touch detection electrode are relatively few, the second touch detection electrodes can as a whole provide a large total area where touch detection is possible.

In the first or second configuration, each of the plurality of second touch detection electrodes may be shaped like a ring surrounding at least two of the plurality of first touch detection electrodes in a plan view (third configuration).

The third configuration can reduce capacitance over a configuration where the second touch detection electrodes are shaped like flat plates. That can in turn reduce drive current and also reduce capacitive coupling between the second touch detection electrodes and the first touch detection electrodes. The reduced drive current enables further decreases in power consumption. The reduced capacitive coupling enables preventing negative effects of changes in the capacitance produced between the second touch detection electrodes and, for example, a finger in a touch detection performed using the first touch detection electrodes and preventing negative effects of changes in the capacitance produced between the first touch detection electrodes and, for example, a finger in a touch detection performed using second touch detection electrodes.

In any one of the first to third configurations, the plurality of first touch detection electrodes may be provided on a substrate, and the plurality of second touch detection electrodes may be provided in a different layer on the substrate than the plurality of first touch detection electrodes may be provided, an insulation layer being interposed between the plurality of first touch detection electrodes and the plurality of second touch detection electrodes (fourth configuration).

In the fourth configuration, the first touch detection electrodes are provided in a different layer than are the second touch detection electrodes. The first touch detection electrodes and the second touch detection electrodes can be therefore formed without making any contacts therebetween even when at least parts of the first touch detection electrodes overlap or intersect with at least parts of the second touch detection electrodes in a plan view.

In any one of the first to fourth configurations, the control unit may perform the detection of the touch using the plurality of second touch detection electrodes with a longer period than using the plurality of first touch detection electrodes.

(fifth configuration).

The power consumption of the touch panel increases with an increasing frequency of touch detection. Nevertheless, the fifth configuration can reduce the frequency of touch detection when no image is being displayed on the touch panel. The fifth configuration can hence further reduce power consumption.

While there have been described what are at present considered to be certain embodiments of the disclosure, it will be understood that various modification may be made thereto, and it is intended that the appended claim cover all such modification as fall within the true spirit and scope of the disclosure.

What is claimed is:

1. A touch-panel-equipped display device comprising:
a touch panel configured to display an image thereon and detect a touch made by a user thereon; and
a control unit configured to control the display of the image and the detection of the touch on the touch panel,
the touch panel including:
a plurality of first touch detection electrodes arranged so as to overlap a display area where the image is displayed in a plan view; and
a plurality of second touch detection electrodes arranged so as to overlap the display area in a plan view, the plurality of second touch detection electrodes being less numerous than the plurality of first touch detection electrodes, wherein
the control unit performs the detection of the touch using the plurality of first touch detection electrodes when the image is being displayed on the touch panel and using the plurality of second touch detection electrodes when no image is being displayed on the touch panel.

2. The touch-panel-equipped display device according to claim 1, wherein each of the plurality of second touch detection electrodes has a larger touch detection area than does each of the plurality of first touch detection electrodes.

3. The touch-panel-equipped display device according to claim 1, wherein each of the plurality of second touch detection electrodes is shaped like a ring surrounding at least two of the plurality of first touch detection electrodes in a plan view.

4. The touch-panel-equipped display device according to claim 1, wherein
the plurality of first touch detection electrodes is provided on a substrate, and
the plurality of second touch detection electrodes is provided in a different layer on the substrate than the plurality of first touch detection electrodes is provided, an insulation layer being interposed between the plurality of first touch detection electrodes and the plurality of second touch detection electrodes.

5. The touch-panel-equipped display device according to claim 1, wherein the control unit performs the detection of the touch using the plurality of second touch detection electrodes with a longer period than using the plurality of first touch detection electrodes.
